(19) United States
(12) Patent Application Publication
(10) Pub. No.: US 2018/0204407 A1
(43) Pub. Date: Jul. 19, 2018

(54) ENCLOSURE WITH INSTANT CHECK-IN SYSTEM

(71) Applicant: Soleluna Inc., Los Angeles, CA (US)

(72) Inventor: RAMOH SALEMON, SAN PEDRO, CA (US)

(73) Assignee: Soleluna Inc., Los Angeles, CA (US)

(21) Appl. No.: 15/874,151

(22) Filed: Jan. 18, 2018

Related U.S. Application Data
(60) Provisional application No. 62/447,735, filed on Jan. 18, 2017.

(51) Int. Cl. G07F 7/08; G06Q 20/20; G07C 9/00; G06Q 20/24; G06Q 50/12

(52) U.S. Cl. CPC G07F 7/08; G06Q 20/204; G06Q 50/12; G06Q 20/24; G07C 9/00896

(57) ABSTRACT

An instant check-in system for a short-term accommodation may include a built-in electronic device, a cloud server and an Application on the user's mobile device to communicate with the cloud server. In one embodiment, the built-in electronic device is a tablet. In another embodiment, the user can use the tablet of the instant check-in system to enter the accommodation. In a further embodiment, the user can use the App to enter the accommodation. The instant check-in system is advantageous because the user who needs a short-term accommodation can simply use either the App on his/her cell phone or the built-in tablet on the accommodation to quickly check in, so he/she does not have to wait in line before a front desk.

### FIELD OF THE DISCLOSURE

The present disclosure relates to an enclosure for users such as travelers, shoppers, students, officer workers; and more particularly to an enclosure for travelers who need a short term rest in airports, bus/train stations, etc.

### BACKGROUND OF THE DISCLOSURE

It is common for travelers to be forced to spend long hours in transportation terminals such as airports, bus terminals, train stations, and the like. For example, the traveler may have become stranded at a transportation terminal due to delays in the arrival or departure of planes, trains, or buses caused by bad weather, or the traveler may have to wait long periods for a connecting bus, train, or flight. The waits in transportation terminals however are generally not long enough to justify the expense and inconvenience of obtaining a hotel or motel room in view of time spent traveling to and from the hotel or motel. For this reason, many forms of short-term accommodations for travelers that fit into preexisting transportation terminal structures have been developed.

U.S. Pat. No. 5,111,626 to Fortune discloses a modular unit having a double shelled module housing closed by a door secured by a locking system and being substantially portable and self-contained requiring only an AC plug and telephone and television lines. A service unit supplies all water and collects ail waste from the modular unit. The modular unit contains a shower, toilet, lavatory and sleeping facilities. However, the entry system of the Fortune patent is inconvenient in that it requires the guest to contact an operator by phone to obtain a three-digit access code in order to gain entry into the facility. Therefore, the traveler's quarters of the Fortune patent suffers the drawback that it requires a relatively large number of personnel for its operation.

U.S. Pat. No. 5,993,216 to Stogner discloses a fixed

or portable multi-functional enclosure that card-operated, climate controlled, and provides a quiet work place for use by students or businessmen, as shown in FIG. 1. The enclosure has a generally semi-oval shaped housing comprising a front portion including a front cowling, a central portion with a curved door, and a rear portion with a lower section and a rear lid. The enclosure housing includes three magnetic card readers located on the opaque front cowling, the curved door, and the rear lid. However, using a card-operated system may be problematic since the user has to carry an additional card that is uniquely coded to access the enclosure. A user may forget to bring the card with him/her. A user may also misplace the special card. Consequently, the user may find the access arrangement cumbersome and inconvenient.

Therefore, there remains a need for a new and improved entry system of a short-term accommodation for travelers to overcome the problems presented above.

### BRIEF DESCRIPTION OF THE DRAWINGS

FIG. 1 illustrates a prior art disclosing a fixed or portable multi-functional enclosure that is card-operated, climate controlled, and provides a quiet work place for use by students or businessmen.

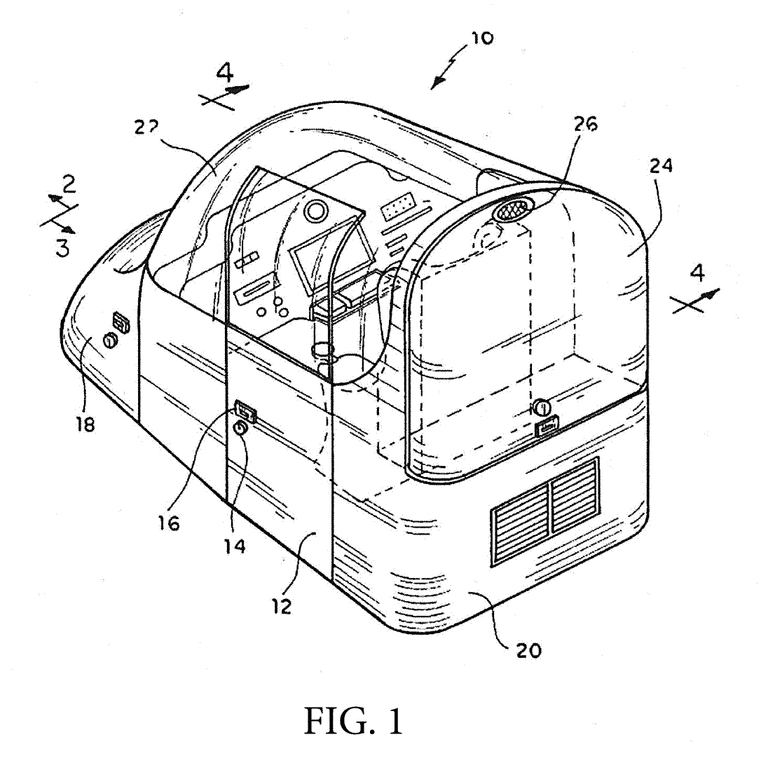

FIG. 2 illustrates a schematic view of the instant check-in system for a short-term accommodation.

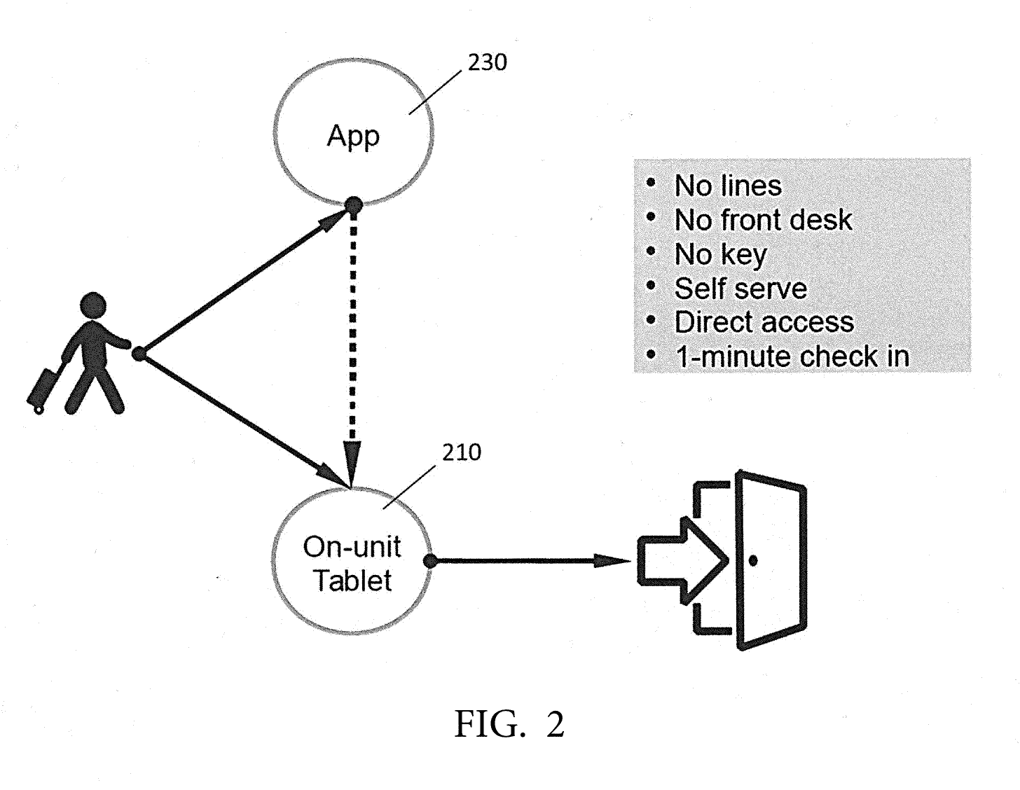

FIG. 3 illustrates another schematic view of the instant check-in system for a short-term accommodation.

FIG. 4 illustrates another schematic view of the instant check-in system for a short-term accommodation when the user has pre-set account information.

FIG. 5 is a flow diagram of the check-in/check-out screen outside the enclosure of the present disclosure.

FIG. 6 is a flow diagram of the Secondary Screen inside the enclosure of the present disclosure.

FIG. 7 is a flow diagram of the pre-registration via Vendor's website of the present disclosure.

FIG. 8 is a flow diagram of the pre-registration check-in in the present disclosure.

FIG. 9 is a flow diagram of the check-in system for a single enclosure of the present disclosure.

FIG. 10 is a flow diagram of the check-in system for multiple enclosures of the present disclosure.

FIG. 11 is a flow diagram of the check-out system of the present disclosure.

FIG. 12 is a flow diagram of services on the secondary inside the enclosure of the present disclosure.

FIG. 13 is a flow diagram of the housekeeping of the enclosure of the present disclosure.

FIG. 14 is a flow diagram of the maintenance of the enclosure of the present disclosure.

FIG. 15 is a flow diagram of monitoring the enclosure of the present disclosure.

FIG. 16 is a flow diagram of a use case when the door will not be opened after successful check-in.

FIG. 17 is a flow diagram of a use case when the door is ajar.

FIG. 18 is a flow diagram of a use case when the user temporarily leaves the enclosure.

FIG. 19 is a flow diagram of a use case when there is an emergency or evacuation.

FIG. 20 is entity relationship diagram showing the databases used in the present disclosure.

### DETAILED DESCRIPTION OF THE DISCLOSURE

The detailed description set forth below is intended as a description of the presently exemplary device provided in accordance with aspect of the present disclosure and is not intended to represent the only forms in which the present disclosure may be prepared or utilized. It is to be understood, rather, that the same or equivalent functions and components may be accomplished by different embodiments that are also intended to be encompass within the spirit and scope of the disclosure.

Unless defined otherwise, all technical and scientific terms used herein have the same meaning as commonly understood to one of ordinary skill in the art to which this disclosure belongs. Although any methods, devices and materials similar or equivalent to those described can be used in the practice or testing of the disclosure, the exemplary methods, devices and materials are now described.

All publications mentioned are incorporated by reference for the purpose of describing and disclosing, for example, the designs and methodologies that are described in the publications that might be used in connection with the presently described disclosure. The publications listed or discussed above, below and throughout the text are provided solely for their disclosure prior to the filing date of the present application. Nothing herein is to be construed as an admission that the inventors are not entitled to antedate such disclosure by virtue of prior disclosure.

The present disclosure is comprised of both an Enclosure Control System (“ECS”) equipped for an individual enclosure (or POD) and an Enclosure Administration System (“EAS”) for managing a subset or the whole inventory of PODs managed by a vendor. ECS for individual enclosure can be activated by a customer's payment source information, or a preauthorized user account number. Payment source information includes items such as virtual currency, credit cards, debit cards, gift cards, etc. In a preferred embodiment, the system only stores portions of the payment source information such as the last four digits of a customer's credit card in its database for future look up. Once activated, the ECS controls or enables the following functionalities of an activated enclosure: (a) Check-In where customers use their credit card to book the enclosure, and use their credit card as key to enter the enclosure or reenter the enclosure after a temporary exit; (b) Check-Out where customers use their credit card to check out and exit the enclosure, and where a bill is created for review by the customer and emailed to the customers. The email may include a link to the vendor's website, or to a third party survey system such as ForeSee or SurveyMonkey for conducting a customer satisfaction survey; (c) monitoring and displaying the status of the enclosure such as “Vacant”, “Occupied”, “Housekeeping,” “Maintenance” to inform the customers whether the enclosure is available for rent or not; (d) controlling devices and appliances inside the enclosure so eh as doors, lights, and power outlets; (e) displaying third party advertisement such as discreet ads on the outside screen alongside the enclosure status when customers are not interacting with the enclosure such as conducting Check-In or Check-Out; (f) performing maintenance and housekeeping audit such as enabling housekeepers and maintenance technician to log their activity and to note any damage or missing items found during housekeeping; (g) chat function that allows customers to engage in live on line chat with a remote call center whenever they have any questions or concerns; (h) provision or optional services through a secondary interactive monitor inside the enclosure (“Secondary Screen”) which allows the customers to order wake-up calls for a small fee, to order concessions, to rent media such as movies, and to contact customer service through operators. The ECS may be controlled by a built-in central controller. The enclosure may be further equipped with a Point of Sale (“POS”) interface. When customers swipe their credit cards, the POS interface will verify and authorize the card to activate the ECS and an available POD. In one embodiment, a mobile app can be developed to allow the customer to book an enclosure in real-time.

The ECS must be able to correctly calculate the total amount owed by the customer based on the number of hours stayed in the enclosure plus any additional services the customer orders/uses from the Secondary Screen within the enclosure, less any coupons applied by the customer. The number of hours stayed can vary depending on the time the enclosure is booked. The following rules may be applied to calculate the number of hours stayed based upon whatever economic model relied upon by the enclosure owner. For example: (i) Total hour is charged up to eight hours on a twelve-hour cycle, with each twelve-hour cycle based on the check-in time. (ii) Each twelve-hour cycle is per single enclosure stay, regardless of location. And (iii) all hours are rounded up to the nearest 30 minute interval. For example, if a person checks in at 4:00 PM and leaves at 5:32 PM, he will be charged for 2 hours. If a customer checks in at 6:30 am and checks out at 6:22 pm for a total of a 12 hour stay, the customer will be charged for 8 hours. If a customer checks in at 7:30 am and checks out at 8:15 pm for a total of 13 hours (7:30 am to 7:30 pm=12 hour cycle, 7:31 pm onwards is another 12-hour cycle), the customer will be charged 8 hours for the first 12 hour cycle, and 1 hour for the next 12 hour cycle for a total of 9 hours. If a customer has a multi-leg pre-registration, each enclosure stay will have its twelve-hour cycle. For example, a customer stays in LAX for 9 hours, and at a DTLA enclosure for 3 hours. He will be charged 8 hours for the LAX stay, and 3 hours for the DTLA enclosure stay. The same will apply if the customer stays in one enclosure, and then transfers to another in the same site; he will be charged for two separate twelve hour cycles.

Corporate accounts may be made available to companies who wish to give hours to their travelling employees. Companies will be able to purchase a block of hours (or have a running tab that will be calculated and charged on a periodic basis). Employees will be given a corporate account card that will be tied to the corporate account and will keep track of the cumber of hours the employee uses. Swiping the corporate card (in lieu of a credit card) will start the timer. The system will then subtract the number of hours stayed from the purchased block of hours (or add the number of hours stayed to the running tab).

The EAS system allows remote management of each individual enclosure and all enclosures as a whole by, for example, the owners of the enclosures, rather than the customers. The management functions include, for example: (a) setting hourly rates for each enclosure based on its location or configuration or other attributes; (b) adding or removing optional services for each enclosure; (c) configuring advertisement settings; (d) controlling devices such as lochs, lights, Secondary Screen within each enclosure via communication with its central controller; (e) communicating with housekeeping in order to ensure that each enclosure is clean and all devices are in working order; (f) controlling and auditing access to the enclosure by housekeeping, maintenance, or management; (g) interfacing with third party systems such as Foresee or SurveyMonkey to download survey results; (h) delegating certain functions to a call center such as remotely controlling devices such as locks, lights, Secondary Screen within each enclosure, performing remote “manual check out” in case of any emergencies, verifying access credentials of housekeeping, maintenance, or management, accessing “stay” and “customer” information in order to answer any questions customers may have regarding their stay; (i) providing optional features such as emailing customers information regarding their stay upon request by the customer, generating coupon (coupons can foe configured to be either a percentage or a fixed amount.) In one aspect, the EAS is implemented remotely at a back office.

For maximum security, in one embodiment, the system is configured as PCI-compliant. In one aspect of the present disclosure, the customers' credit card is used, e.g., as the “key”, to unlock the door and activate the ECS. This necessitates storing sensitive financial information. All sensitive information will be encrypted using approved standards. In a preferred embodiment, all sensitive information about the customer will be stored in a cloud server instead of stored inside the POD. The system may use a role-based authentication method. Each user belongs to a certain role, or group, with each role having specific permissions. One role is a system administrator who can do all system functions, including adding/modifying/deleting users, viewing audit logs, etc. Another role is a content administrator who can use the EAS to modify content in the system, such as setting up stay rates, adding optional services, etc. Another role can be support who may use the EAS to view enclosure status, or view customer and stay information including charge information, or view Maintenance or Housekeeping information, or view and update Maintenance or Housekeeping notes (e.g. damages, etc.); or remotely control devices such as unlocking doors. Another role can be a Maintenance or Housekeeping role who can use the ECS to enter status of the enclosure as well as add notes to the systems.

In a preferred embodiment or embodiments, all user activity on the ECS and EAS will be stored in audit logs. In one aspect, the audit logs will be stored in a cloud server for maximum security. This includes all activity such as modifying rates, accessing customer logs, etc., done by persons having various roles. This also includes all customer activities such as what services were accessed. User entry into (ingress) and exit out (egress) of the enclosures must be stored as well, including customer access, housekeeping access, and maintenance access. The system must be able to identify who performed the activity. Audit logs is preferred to be readable only. All financial transactions must be secure and compliant with all industry standards. The vendor website must follow all recommended industry security practices and must be compliant with all industry standards. All website activity must be stored in audit logs. Audit logs must be read-only. Card reader must be inspected regularly to protect against skimming and other hacking activity.

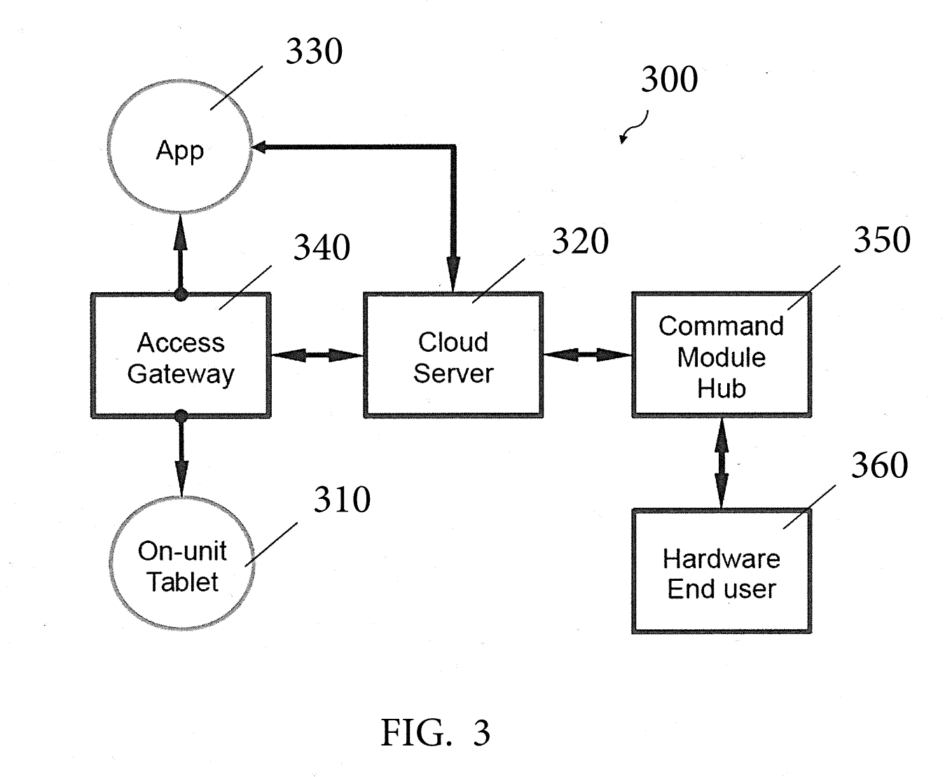

In one aspect, as shown in FIG. 3, an instant check-in system for a short-term accommodation for travelers may include a built-in electronic device 310, a cloud server 320 and an Application (“App”) 330 on a customer's mobile device to communicate with the cloud server 320. In one embodiment, the built-in electronic device 310 is a tablet. In another embodiment, the user can use the tablet 310 of the instant check-in system to enter the accommodation. In a further embodiment, the user can use the App 330 to enter the accommodation. The instant check-in system is advantageous because the traveler who needs a short-term accommodation can simply use either the App on his/her cell phone or the built-in tablet on the enclosure to quickly check in, so he/she does not have to wait in line before the front desk. Also, it is unnecessary for the traveler to carry a key, so it is very convenience for travelers especially in the airport or bus/train station for a short rest in a private enclosure.

The instant check-in system may further include an access gateway 340 to communicatively connect with the built-in electronic device 310 and the App 330, and the access gateway 340 is also communicatively connected with the cloud server 320, so the traveler can enter the commands either from the built-in electronic device 310 or the App 330 on the his/her mobile device, and the commands will be transmitted to the cloud server 320.

The traveler's commands will further be processed and transmitted to a command module hub 350, which is communicatively connected with a hardware 360. In one embodiment, the hardware 360 can be any device or appliance in the enclosure that can be controlled by the command. For example, the traveler can either use the built-in tablet or the App to open the door without using a key.

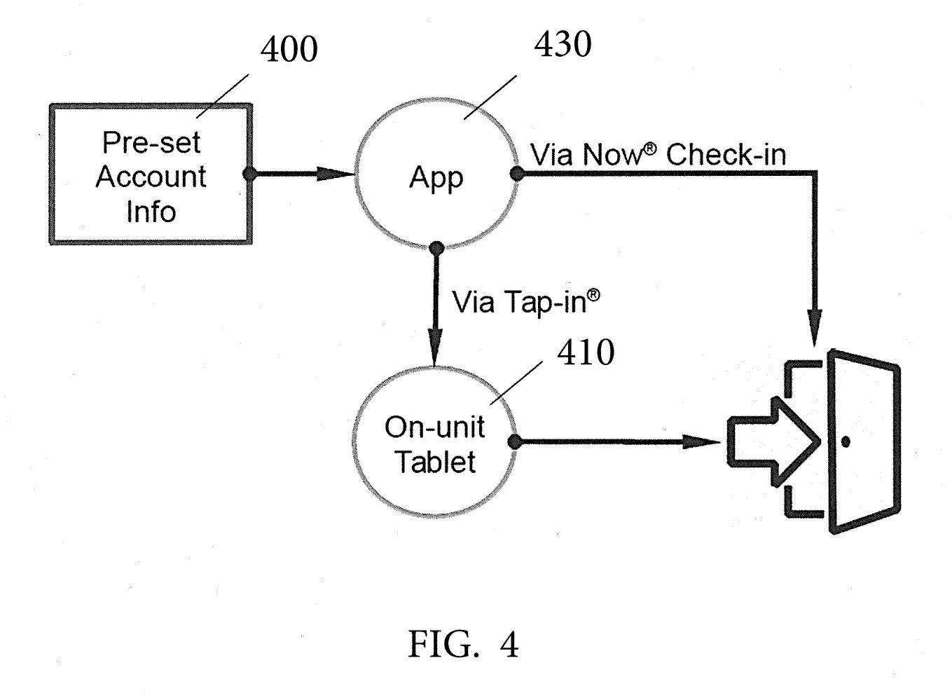

In a further embodiment, as shown in FIG. 4, the user or traveler may have a pre-set account 400 related to the instant check-in system. More specifically, the pre-set account 400 may include some of the user's basic information such as the user's name, preference, credit card information, etc. so the user may just have to enter the account number into either the App 430 or the built-in tablet 410 to operate the enclosure.

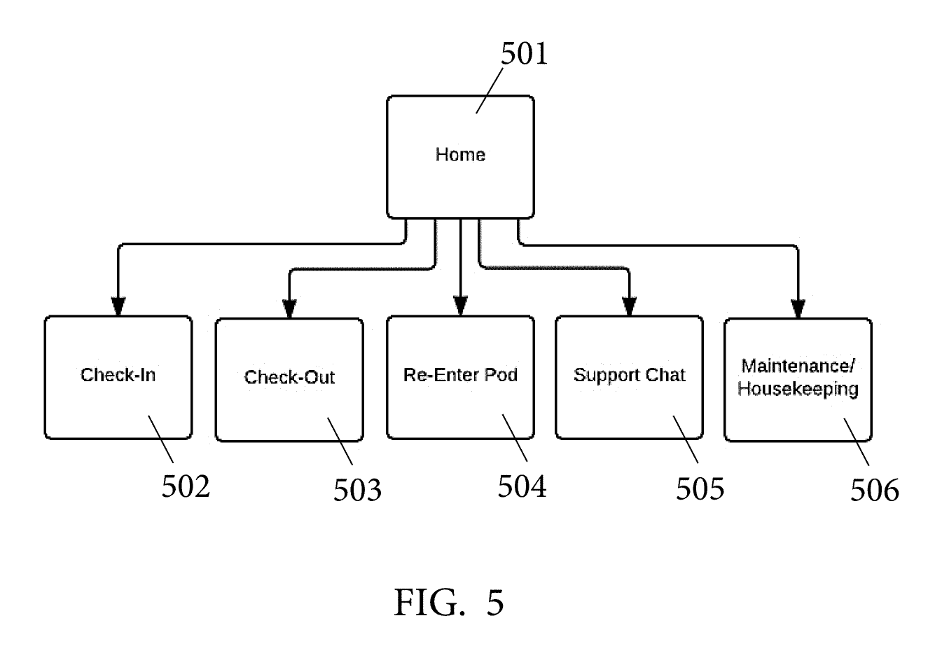

In a preferred embodiment, the user interface to the ECS is configured to be simple and easy to navigate. In one embodiment, the ECS interface is a main display screen outside the enclosure. FIG. 5. The outside screen always displays the enclosure number, enclosure status and the current time. Background may have visible cues as to whether the enclosure is available or not-for example, the background can be a shade of green when available, a shade of red when not available. Also, “Check-In” 502, “Check-Out” 503, “Re-Enter POD” 504, “Support Chat” 505 are configured easily readable and clearly marked buttons from the outside screen. In one preferred embodiment, the outside screen is a touch screen. Instructions may be worded clearly such as “Please Swipe Card to Book Enclosure.” In a preferred embodiment, navigation should allow the customer to cancel back to the Home screen at any time. “Chat” button should be easy to find and allow for an on-screen keyboard and option should be available to allow advertising to be displayed discreetly on screen.

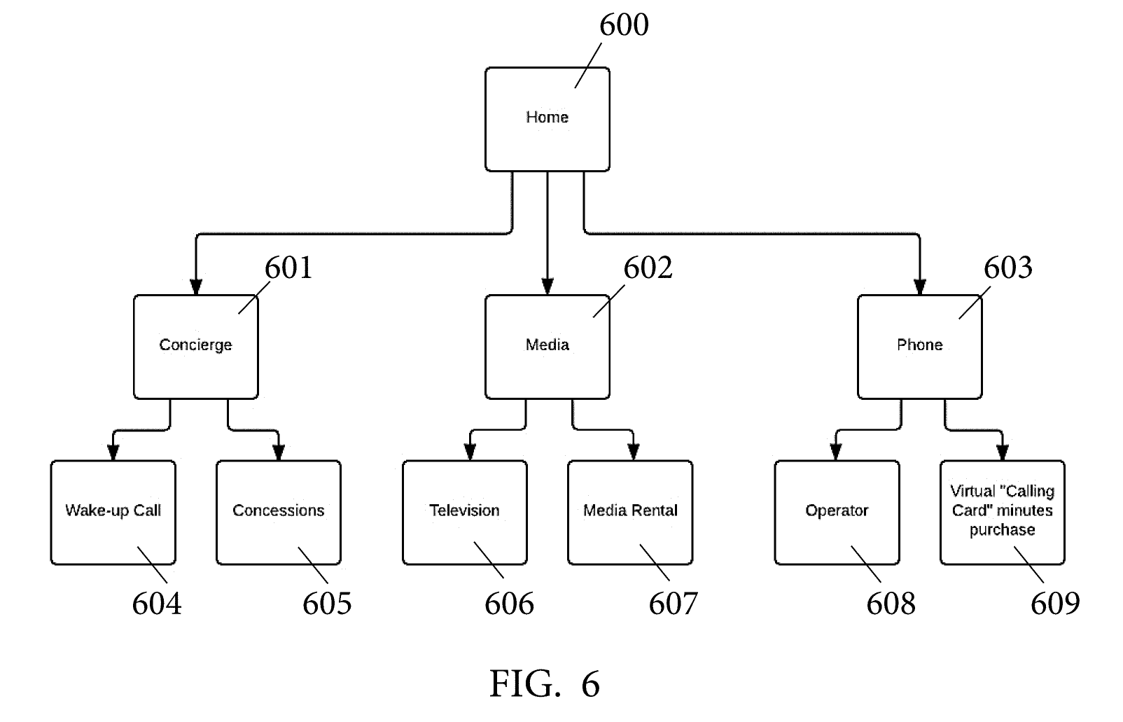

In another embodiment shown in FIG. 6, the enclosure may be equipped with a Secondary Screen inside. The Second Screen may be set up to always display a POD number, current time, and Check-in time in its Home screen mode 600. When the Secondary Screen is activated via touch the main menu should appear. The menu may be comprised of the following clickable buttons and functionalities. A Concierge button 601, a Media button 602, and a Phone button 603. Touching the Concierge button opens up additional options to order services such wake-up call 604 or concessions 605. Wake-up all will allow the customer to set a wake-up call time. Concessions brings up a menu that the customer can order food from. In one embodiment, the concessions ordering functionality is linked to concessionaire's system and the concession order is getting transmitted along with the enclosure location and number. Touching the Media button allows the customer to enjoying media such as watching television 606 or rental media 607. Touching the Phone button may allow the Customer to purchase call minutes 609, or a virtual calling card, in order to unlock the softphone included on the Secondary Screen. Touching the Phone button may also give the customer the option to speak to an Operator via the softphone included on the Secondary Screen.

In a preferred embodiment, the ECS muse be usable on a touchscreen, whether using a tablet or a touch screen monitor attached to a PC. The ECS and EAS must be able to uniquely identify each enclosure and correctly associate it with each stay. This information must also be accurately relayed to the back-office. Also, the ECS must be able to interface with a Point of Sale (“POS”) system via an attached EMV device. It may be compatible with magnetic stripe cards, chip enabled cards, and mobile payments such as Apple Pay and Google Wallet.

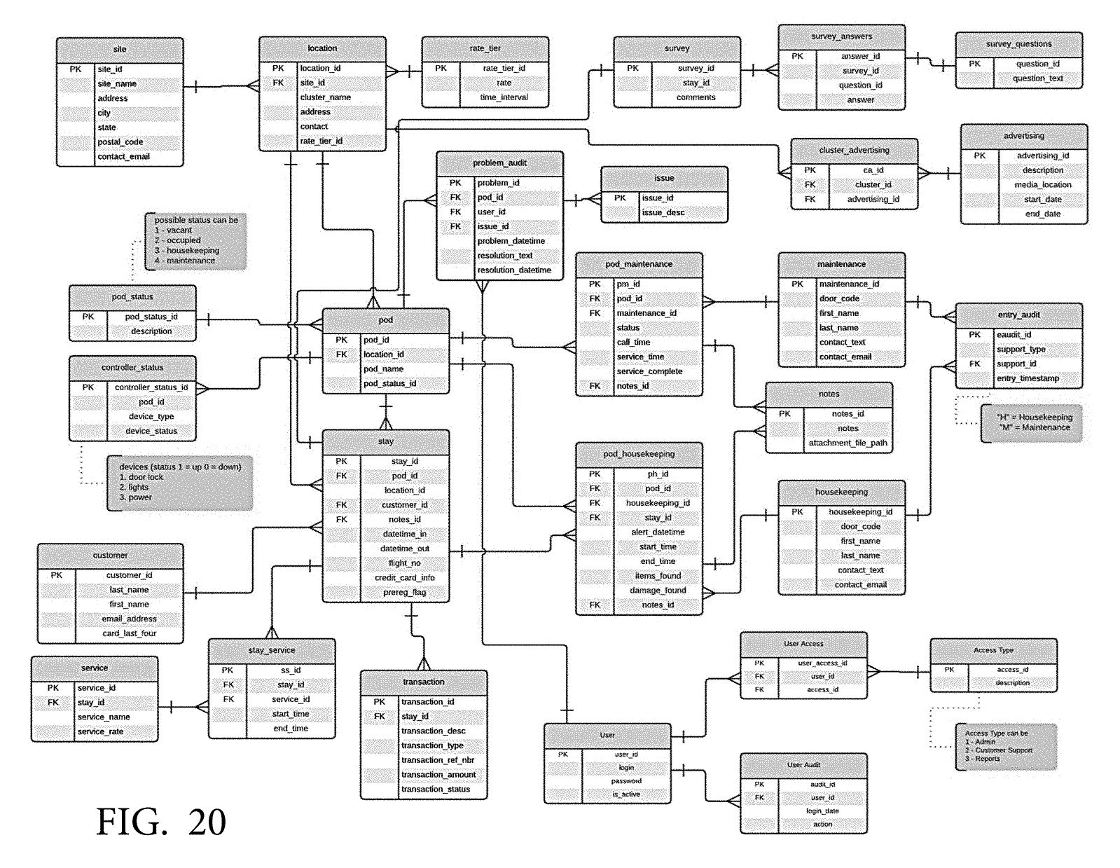

The ECS may allow two way chats between a customer and a call center in case of any questions and be able to communicate with a smart controller such as Wink in order to control devices such as lights and door locks. The ECS may be able to unlock the door of the enclosure using a card swipe (or any other interaction with the EMV device). In a preferred embodiment, the EAS must be able to communicate with a smart controller such as Wink in order to control devices such as lights and door locks remotely and to poll the smart controller on a set interval to determine the status of all attached devices. If a device is down, the EAS may alert the call center. The ECS and EAS are capable of writing data to the existing Enclosure database. See FIG. 20 ER Diagrams. The ER diagram may be updated as needed.

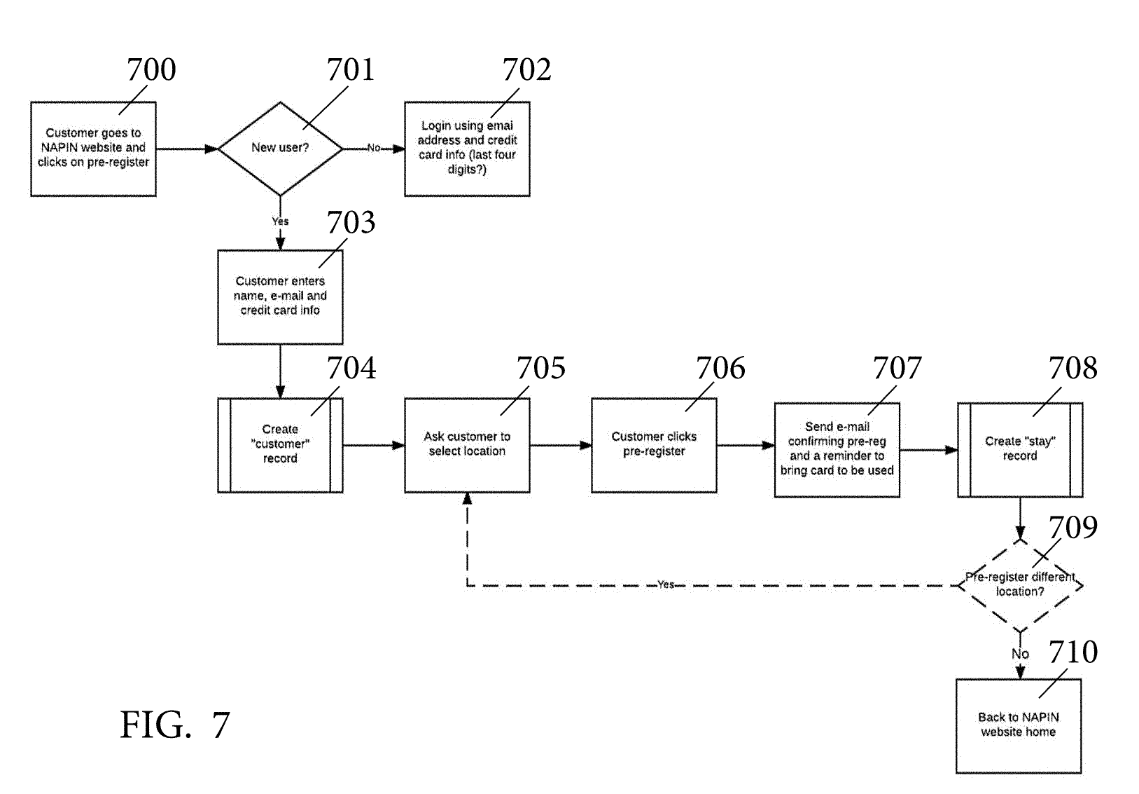

FIG. 7 shows a pre-registration process for users to take advantage of the instant check-in feature. A customer is encouraged to pre-register for use of an enclosure via the vendor's website (e.g., NAPINPOD™ website). The website will check if the customer is a new user or not 701. If the customer is a first time user, the website will require that the customer input basic contact information such as his or her full name and email address 703. The website will also ask the customer to input payment information such as credit card data 703. A record is created for this customer 704. The customer is prompted to select a location where the customer plans to use an enclosure 705. Once the customer selects a location, the customer clicks a pre-registration link from the website 706. A confirmation email will be generated and sent to the customer's email address on record 707. The email may remind the customer to bring his or her registered credit card for checking into the enclosure. In another aspect, the customer may also pre-register his or her stay at a different location 709, or at multiple locations. Once the customer completes the pre-registration step, he or she can exit back to the vendor's home page 710. In another aspect, the customer may also pre-register his or her stay at a different location 709, or at multiple locations. Once the customer complete the pre-registration step, he or she can exit back to the vendor's home page 710. If at step 701 the customer is confirmed to be a return user, he or she will be prompted to log into the system directly using his or email address and credit card information 702. In one embodiment, the customer may use the last four digits of the credit card number to log in.

In the ECS and EAS systems, upon completion of pre-registration, a “Stay” record is generated to record the booking 708. A “Stay” record may contain several data fields such as stay_ID, POD_ID, location_ID, customer_D, notes_ID, datetime_in, datetime_out, flight_no, credit_card_info, prereg_tag etc. At the completion or the pre-registration, the prereg_tag for the stay record will be assigned a value of Y. Customer inputs will be used to populate the applicable data fields. In one embodiment, the systems only record into credit_card_info the last four digits of the customer's credit card number. Other data fields could be preassigned by the systems. A “customer” record may also be generated upon completion of pre-registration and populated accordingly. The Customer record may contain several data fields such as customer_ID, first_name, last_name, email_address, credit_card_info. Each time a user interacts with the vendor via website or app or through the enclosure directly, the systems may also create a “Transaction” record. A Transaction record may contain several data fields such as Transaction_ID, stay_ID, transaction_desc, transaction_type, transaction_ref_nbr, transaction_amount, and transaction_status. Information about the enclosure itself may be also recorded in data fields such as POD_ID, location_ID, POD_name, Pod_status_ID, Description, etc.

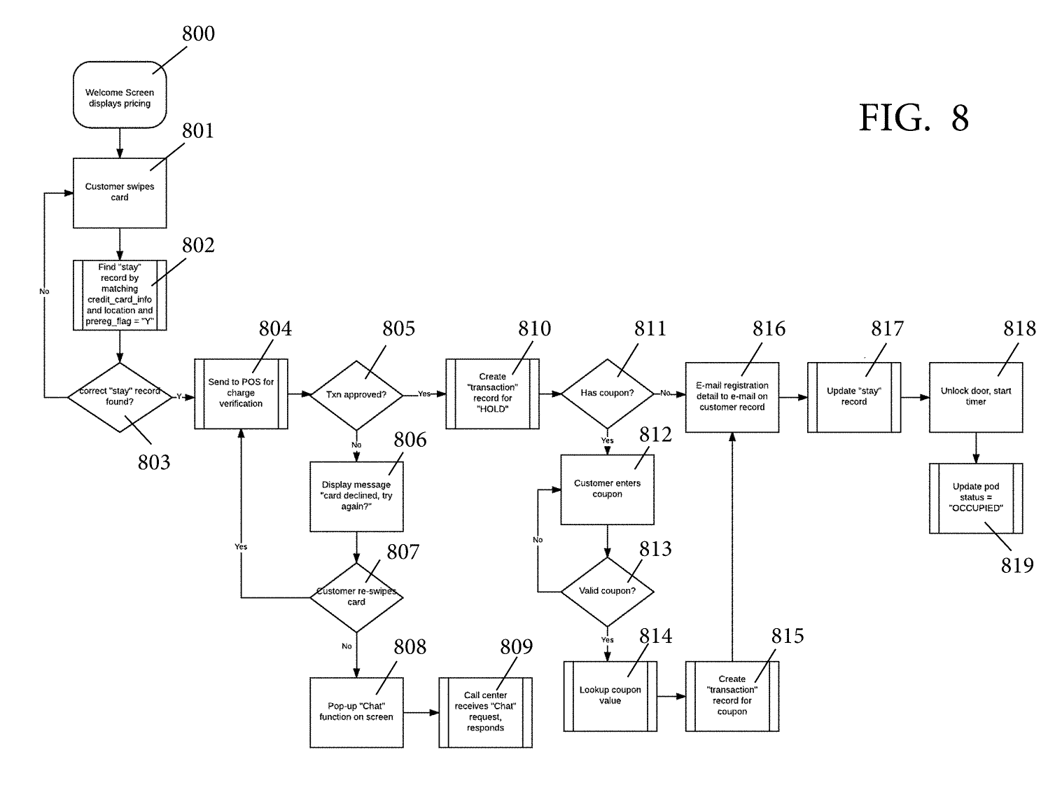

FIG. 8 shows the Check-in process for a customer who has preregistered. When the customer approaches an enclosure, he or she will face a display that is affixed to the outside of the enclosure. The home screen of the outside display may display a welcome message 800. The home screen may display a POD number, current time, and the current POD status. In one embodiment, the welcome screen may also display pricing information for using the enclosure 800. The customer may swipe the credit card that he or she used to pre-register to a POS device affixed to the outside of the enclosure 801. In one embodiment, the ECS system will use the credit card information to locate the stay record that was created at pre-registration. If a Stay record is found with matching credit_card_info, matching location information, and the prereg_flag of the Stay record is set as Y 803, the POS device will further process the customer's credit card for verification 804. If the credit card is declined, the outside screen will display an error message such as “Card declined. Try again?” 806. The customer may swipe the credit card again 807. If the credit card verification fails repeatedly, a chat window will be popped up on the outside screen 808. The chat window will allow the customer to send request to the vendor's call center and receive responses 809. For example, the vendor's call center may allow a live chat with the customer. Upon verification of the credit card information, the system may create a HOLD Transaction record 810. In one embodiment, the values for various data fields will be populated as follows. transaction_desc equals “HOLD,” transaction_type equals “HOLD,” transaction_ref_nbr is assigned by the POS device, transaction_amount equals a HOLD deposit that system charges, and transaction_status equals “HOLD.” In one embodiment, the system may charge a $200 HOLD deposit fee. The system may further check if the customer has a coupon 811. If so, the system will prompt the customer to enter the coupon code via the outside display screen 812. The system will verify if the coupon is valid or not 813. If the coupon is valid, the system will look up the coupon value 814, and create a Transactional record for the coupon 815. As an example, the Transaction record may have an associated stay_ID, the value for transaction_desc will be “COUPON,” the value for transaction_type will be “PERCENT,” the value for transaction_amount is equivalent to the lookup value of the coupon, and the value for transaction_status will be “COUPON.” Regardless of whether the customer presents a coupon or not, and regardless of whether the coupon is valid or not, the system will email the registration details to the customer 816. The customer's Stay record will be updated 817. In one embodiment the POD_ID will be assigned a value of the actual pod that the customer Checks-in. The value of customer_ID will be updated to the current customer. The value of datetime_in will be current date. The credit_card_info will be also updated. The door to the enclosure will be unlocked 918. The customer may now enter. The system will start the timer. The system will update the POD_status description to “OCCUPIED” 819.

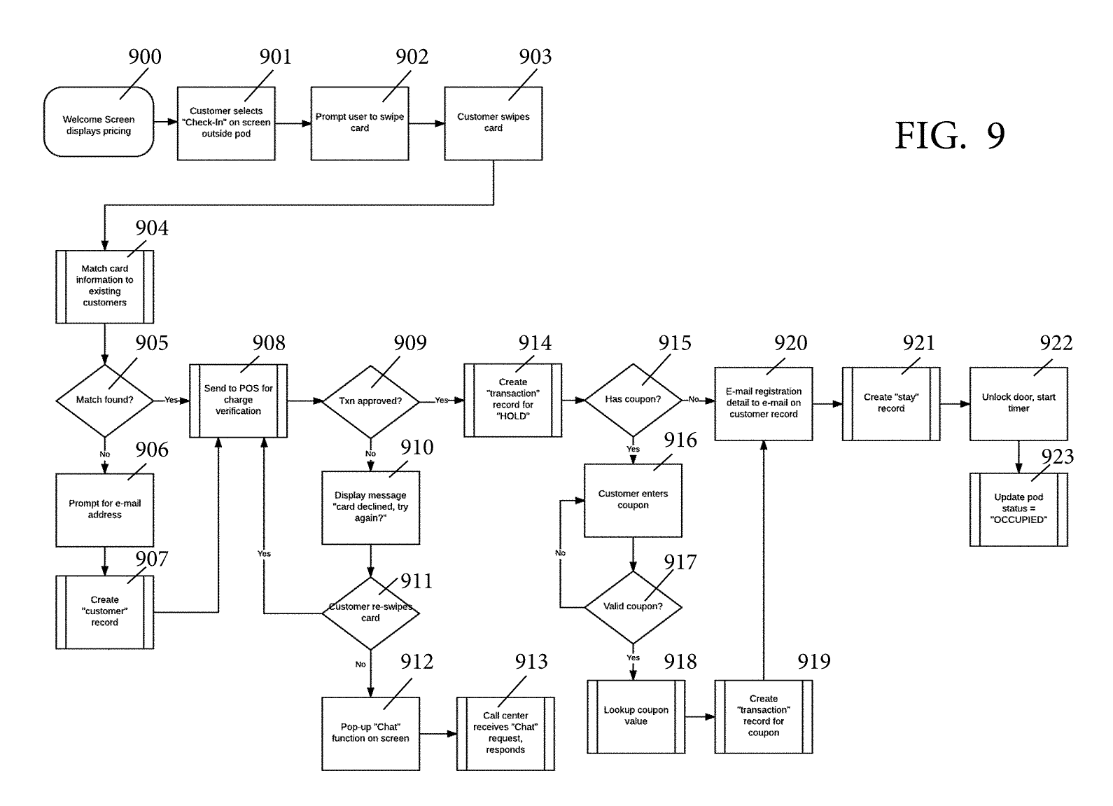

FIG. 9 shows the process for a customer to perform a Check-in to a single POD system without pre-registration. When a customer approaches an enclosure, he or she will first face the outside display screen. The screen displays a welcome message. The home screen may also display a POD number, current time, and the current POD status. In one embodiment, the home screen may also display pricing information for using the enclosure 900. The welcome screen may have a few clickable buttons. The customer may click on a Check-in button from the welcome screen 901. The customer will be prompted to swipe his or her credit card to a POS device affixed to the outside of the enclosure 903. If the customer does not swipe the credit card within 15 minutes, the screen will revert back to the welcome screen. The system uses the credit card information to check if the customer's information is already stored in the system. If a match is found 905, the POS device will further process the customer's credit card for verification 908. If a match is not found, the system may prompt the customer to input his or her email address 906. The system then creates a Customer record 907. The Customer record would store the customer's email address and credit card information to the email_address and credit_card_info data fields. After the Customer record is created, the system will use the POS device to verify the customer's credit card information 908.

If the customer's credit card is declined, the outside screen will display an error message such as “Card declined. Try again?” 910. The customer may swipe the credit card again 911. If the credit card verification fails repeatedly, a chat window will foe popped up on the outside screen 912. The chat window will allow the customer to send request to the vendor's call center and receive responses 913. For example, the vendor's call center may allow a live chat with the customer. Upon verification of the credit card information, the system may create a HOLD Transaction record 914. In one embodiment, the values for various data fields will be populated as follows. transaction_desc equals “HOLD,” transaction_type equals “HOLD,” transaction_ref_nhr is assigned by the POS device, transaction_amount equals a HOLD deposit that system charges, and transaction_status equals “HOLD.” In one embodiment, the system may charge a $200 HOLD deposit fee. The system may further check if the customer has a coupon 915. If so, the system will prompt the customer to enter the coupon code via the outside display screen 916. The system will verify if the coupon is valid or not 917. If the coupon is valid, the system will look up the coupon value 918, and create a Transactional record for the coupon 919. As an example, the Transaction record may have an associated stay_ID, the value for transaction_desc will be “COUPON,” the value for transaction_type will be “PERCENT,” the value for transaction_amount is equivalent to the lookup value of the coupon, and the value for transaction_status will be “COUPON.” Regardless of whether the customer presents a coupon or not, and regardless of whether the coupon is valid or not, the system will email the registration details to the customer 920. The system will create a Stay record 921. The POD_ID field of the Stay record will be assigned a value of the current pod. The value of customer_ID will be the current customer. The value of datetime_in will be current date. The credit_card_info will be the accepted credit card. The door to the enclosure will toe unlocked 922. The customer nay now enter. The system will start the timer. The system will update the POD_status description, to “OCCUPIED” 923.

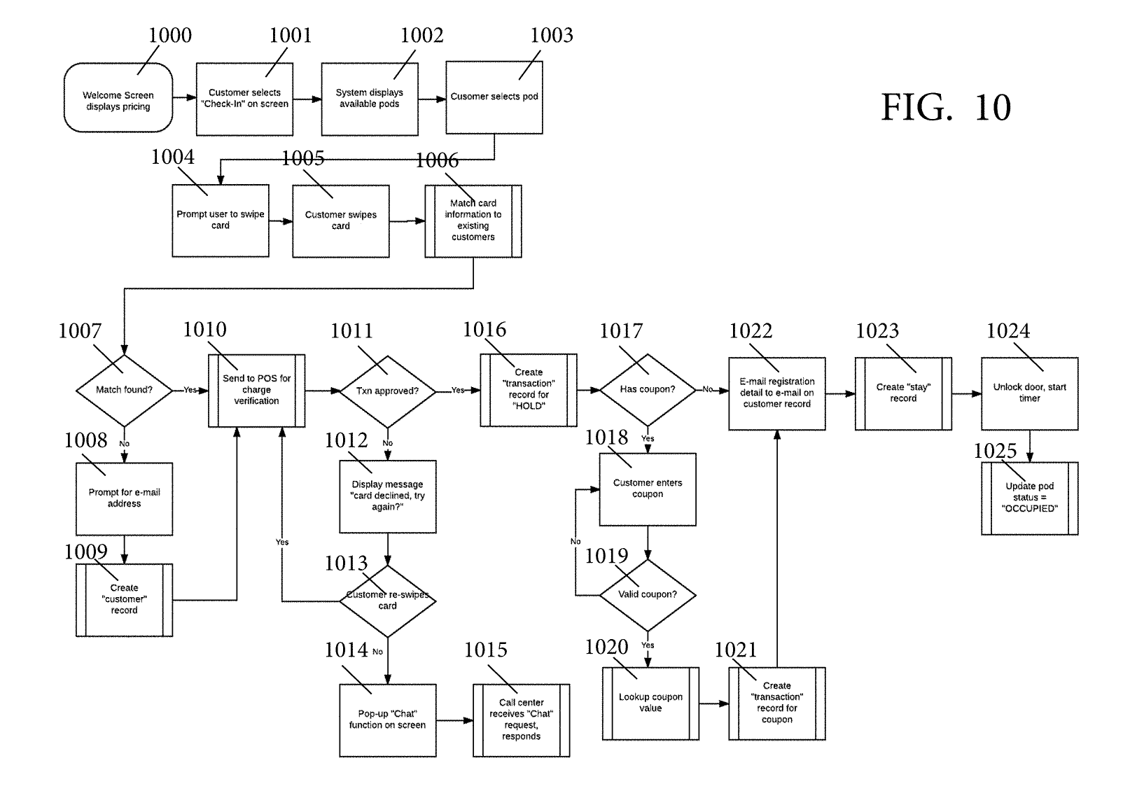

FIG. 10 shows the process for a customer to perform a Check-in to a multiple POD system without pre-registration. When a customer approaches the system, he or she may face find a multiple POD system having a centralized screen. The screen may be affixed to a specific enclosure. In another embodiment, it may be a standalone screen. The screen displays a welcome message. The home screen may also display current time. In one embodiment, the home screen may also display pricing information for using the enclosures 1000. The screen may have a few clickable buttons. The customer may click on a Check-in button from the welcome screen 1001. What gets shown on the screen next will be all enclosures that are available within the multi POD system 1002. The customer may select a specific enclosure 1003. The customer will be prompted to swipe his or her credit card to a POS device affixed to the outside of the enclosure 1004. If the customer does not swipe the credit card within 15 minutes, the screen will revert back to the welcome screen. The system uses the credit card information to check if the customer's information is already stored in the system 1006. If a match is found 1007, the POS device will further process the customer's credit card for verification 1010. If a match is not found, the system may prompt the customer to input his or her email address 1008. The system then creates a Customer record 1009. The Customer record would store the customer's email address and credit card information to the email_address and credit_card_info data fields. After the Customer record is created, the system will use the POS device to verify the customer's credit card information 1010.

If the customer's credit card is declined, the outside screen will display an error message such as “Card declined, Try again?” 1012. The customer may swipe the credit card again 1013. If the credit card verification fails repeatedly, a chat window will be popped up on the outside screen 1014. The chat window will allow the customer to send request to the vendor's call center and receive responses 1015. For example, the vendor's call center may allow a live chat with the customer. Upon verification of the credit card information, the system may create a HOLD Transaction record 1016. In one embodiment, the values for various data fields will be populated as follows: transaction_desc equals “HOLD,” transaction_type equals “HOLD,” transaction_ref_nbr is assigned by the POS device, transaction_amount equals a HOLD deposit that system charges, and transaction_status equals “HOLD.” In one embodiment, the system may charge a $200 HOLD deposit fee. The system may further check if the customer has a coupon 1017. If so, the system will prompt the customer to enter the coupon code via the outside display screen 1018. The system will verify if the coupon is valid or not 1019. If the coupon is valid, the system will look up the coupon value 1020, and create a Transactional record for the coupon 1021. As an example, the Transaction record may have an associated stay_ID, the value for transaction_desc will be “COUPON,” the value for transaction_type will be “PERCENT,” the value for transaction_amount is equivalent to the lookup value of the coupon, and the value for transaction_status will be “COUPON.” Regardless of whether the customer presents a coupon or not, and regardless of whether the coupon is valid or not, the system will email the registration details to the customer 1022. The system will create a Stay record 1023. The POP_ID field of the Stay record will be assigned a value of the current pod that the customer selects. The value of customer_ID will be the current customer. The value of datetime_in will be current date. The credit_card_info will be the accepted credit card. The door to the enclosure will be unlocked 1024. The customer may now enter. The system will start the timer. The system will update the POD_status description to “OCCUPIED” 1025.

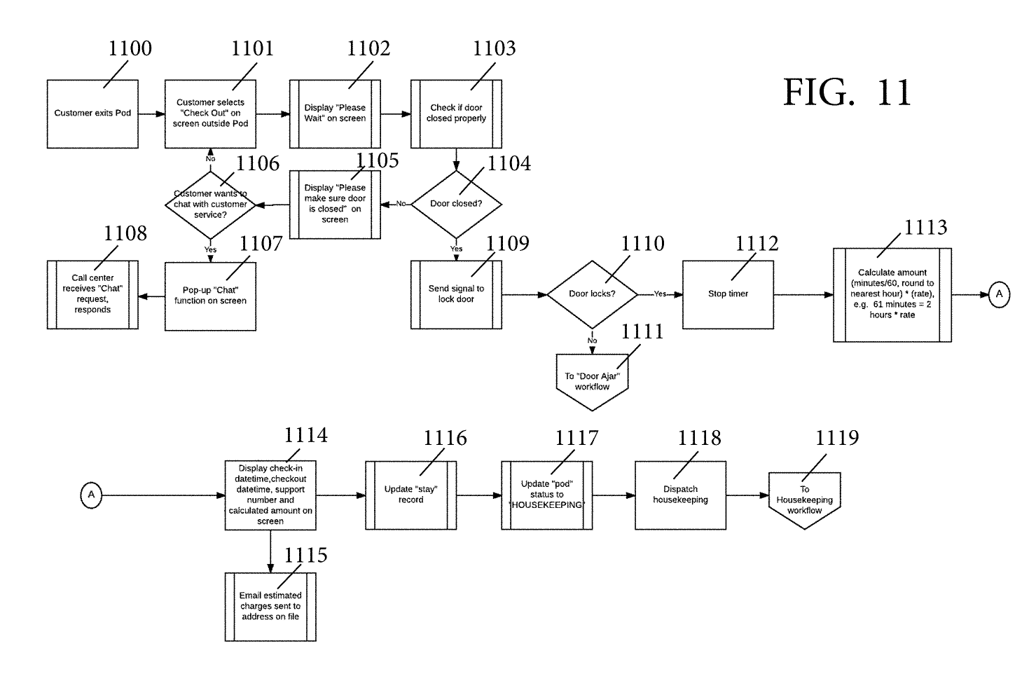

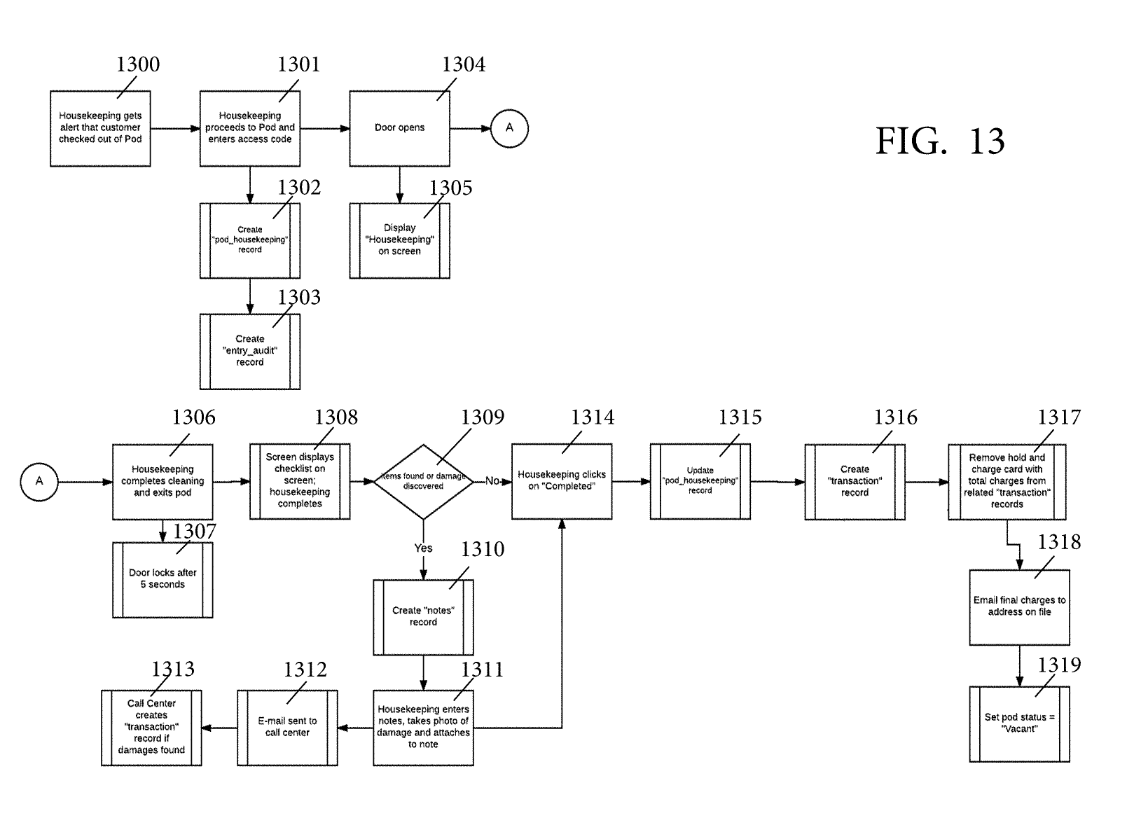

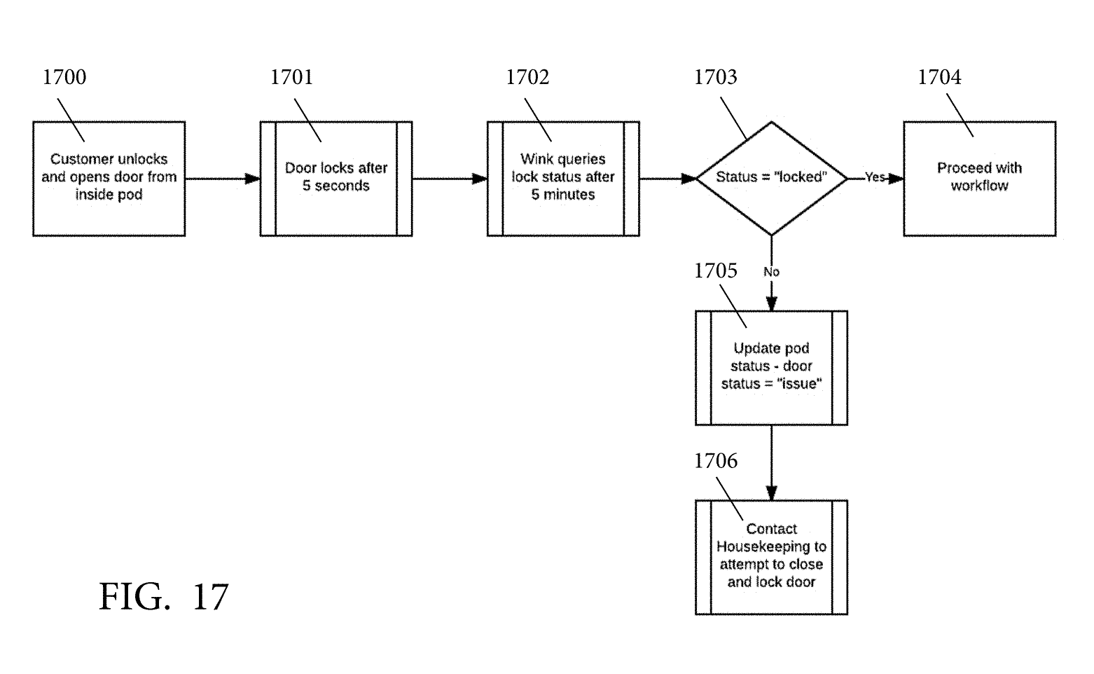

FIG. 11 shows the steps for a customer to perform a Check-Out. When the customer exits the enclosure, he or she may approach the outside screen and click on the Check-Out button from the screen 1101. The outside screen may display a “Please Wait” message 1102. The system will check meanwhile if the door is closed properly 1103. If the door is not closed properly, a “Please make sure door is closed” message will be displayed 1105. If the customer has trouble properly closing the door, he or she may go back to the home screen, and the screen will prompt the customer and check if he or she wants to chat with the call center 1106. If the customer selects yes, a chat window will pop up on the outside screen 1107. The chat window will allow the customer to send request to the vendor's call center and receive responses 1108. If the door is closed properly, the ECS system will send a signal to lock the door 1109. If the door cannot be locked, the system will initiate a Door Ajar process as described in FIG. 17 below. If the door probably locks, then the system will stop the timer 1112. The system then proceeds with invoice generation. In one embodiment, it calculates a stay charge by rounding up the duration of the customer's stay to the nearest hour, and multiply that with the hourly rate 1113. The invoice would include any optional service that the customer may have ordered during his or her stay inside the enclosure. The invoice may exclude all customer discounts such as applicable coupons. In one embodiment a preliminary invoice may be displayed on the outside screen 1114. The preliminary invoice may include one customer's check-in datetime, the customer's check-out datetime, and show how the amount is calculated. A copy of the preliminary invoice can be sent to the customer's email address 1115. In one embodiment, such invoice would not be finalized until the housekeepers sign off on the enclosure after inspection. Upon Check-out, the system will update the customer's stay record 1116 by populating the value for the checkout_datetime field. The system will further update POD_status description to “HOUSEKEEPING,” 1117 and dispatch for housekeeping 1118. The process for housekeeping will be described below in FIG. 13.

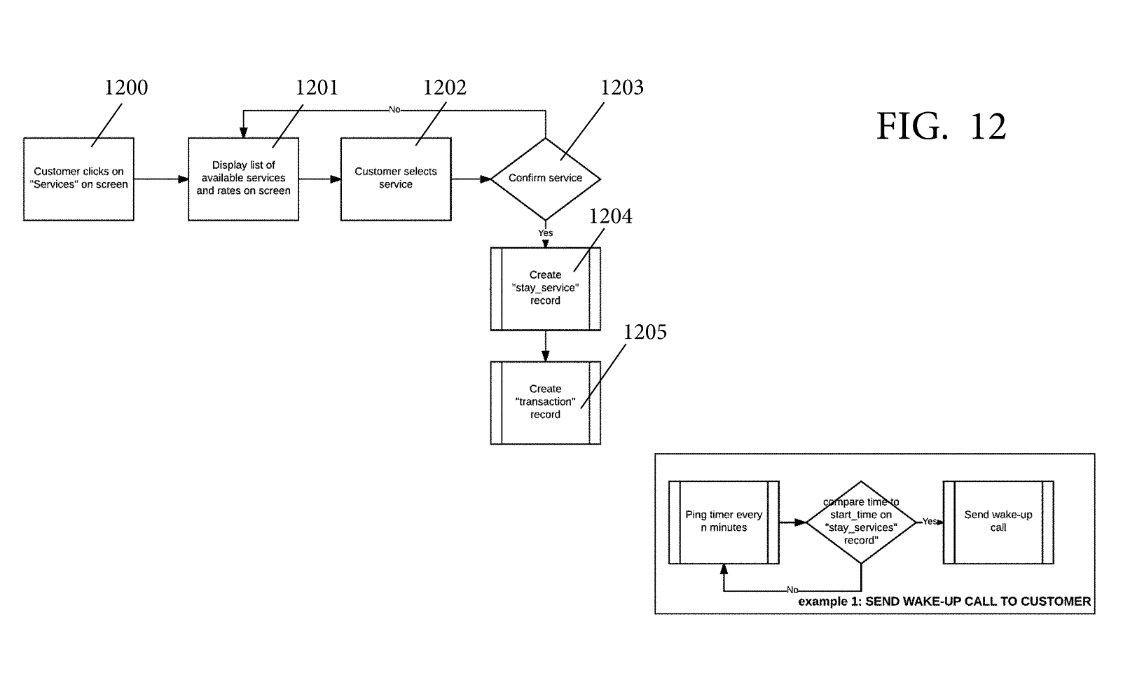

FIG. 12 shows an embodiment where a customer may request service from inside the enclosure. In one embodiment, the inside of the enclosure may be equipped with a Secondary Screen. The Secondary Screen may have a home screen as well as multiple buttons for navigating through different screens and functionalities. Touching the Secondary Screen may bring up a list of available services, along with service rates for each 1201. The customer may select one or more services by touching corresponding service buttons 1202. The customer may be required to confirm the services that he or she selects. If confirmed, the system will create a Stay_Service record 1204 and a Transaction record 1205. The Stay_Service record may contain data fields such as Stay_ID, Service_D, Stay_Service_ID, Start_time, and End_time. The values may be preassigned by the ECS system, and/or generated based on the customer's inputs. The data fields for the Transaction record may be populated as follows: value for Stay_ID derives from the Stay record, value for transaction_desc is equal to the service chosen by the customer, value for the transaction_type is equal to service chosen, value for transaction_amount equals the cost of the service chosen, and value for transaction_status equals “charge.” One exemplary service that may be provided inside the enclosure is a wake-up service. The system can be set up to ping its timer for every number of minutes (e.g., every 15 minutes), the system will compare the timer to the Start_time on the Stay_Service record. When the timer runs up, the system will send a wake-up call to the enclosure.

FIG. 13 shows an exemplary process for performing housekeeping of the enclosure. The housekeeper gets an alert after a customer checks out of the pod 1300. The housekeeper then proceeds to the enclosure and enters his or her access code 1301. If the access code is correct, the door opens and the housekeeper can enter to do cleaning and other housekeeping. The outside screen would display the POD status as “HOUSEKEEPING” 1305. When the housekeeper enters his or her access code, the ECS system creates a POD_Housekeeping Record 1302 and an Entry_audit Record 1303. The POD_Housekeeping Record may contain the following data fields: POD_ID, Stay_ID (storing the most recent stay by a customer), Housekeeping_ID that correspond to the housekeeper's access ID, and start_time. A Stay_ID is a desired field for POD_Housekeeping Record to enable tracking of the last person who left items behind or caused damages to the enclosure. The Entry_audit Record may contain the following data fields: Support_type, Support_ID, Entry_timestamp, etc. The values for these data field may be assigned respectively “Housekeeping” for Support_type, the housekeeper's ID number for Support_ID, and the current date and time for the Entry_timestamp. When the housekeeper completes cleaning and exits the enclosure 1306, the system will automatically lock the door after 5 seconds 1307. Upon exit and door closure, the outside screen displays a housekeeping completion checklist 1308. The checklist may include inquiries such as whether there are any items left behind by the customer, whether damages are found, etc. The checklist may also allow the housekeeper to prepare notes. For example, the housekeeper may be prompted by the outside screen to confirm if he or she has discovered any lost or damaged items 1309. If so, the housekeeper is tasked with taking notes for record keeping 1310. The housekeeper may create the note through manual input of all missing times, taking photos of the damaged items and attaching them, etc. 1311. The system would email the note to a call center 1312. The call center may create a Transaction Record if any item is found missing or damaged 1313. The data fields for the Transaction Record may be populated as follows: value for stay_ID drives from the Stay record, value for transaction_desc equals “damage,” value for transaction_type equals “damage,” value for transaction_amount is to be calculated by the call center, and value for transaction_status equals “charge.” The housekeeper clicks on a “Completed” button if no missing or damaged items are found 1314. Alternatively, the housekeeper clicks on a “Completed” button after uploading notes and photos to the system 1314. The system will then update the POD_Housekeeping Record 1315. The update includes populating these data fields with updated values: End_time, items_found, damages, and notes. The system will also create a Transaction record 1316. The data fields for the Transaction Record may be populated as follows: value for stay_ID drives from the Stay record, value for transaction_desc equals “checkout,” value for transaction_type equals “hourly_charge,” value for transaction_amount is to be calculated by multiplying the number of hours stayed with the hourly rate, and value for transaction_status equals “charge.” Finally, the system will review all related Transaction Records. Related Transaction records include records reflecting any optional services that customer may have ordered, records reflecting damages to the enclosure if any, and records reflecting applicable coupon discounts etc. The system will aggregate all charges or discounts across all Transaction, and calculate a final charge. The system will charge the credit card on file and remove HOLD 1318. A finalized invoices will be sent to the customer's email address on file 1318. The POD_status description will be reset to “Vacant.”

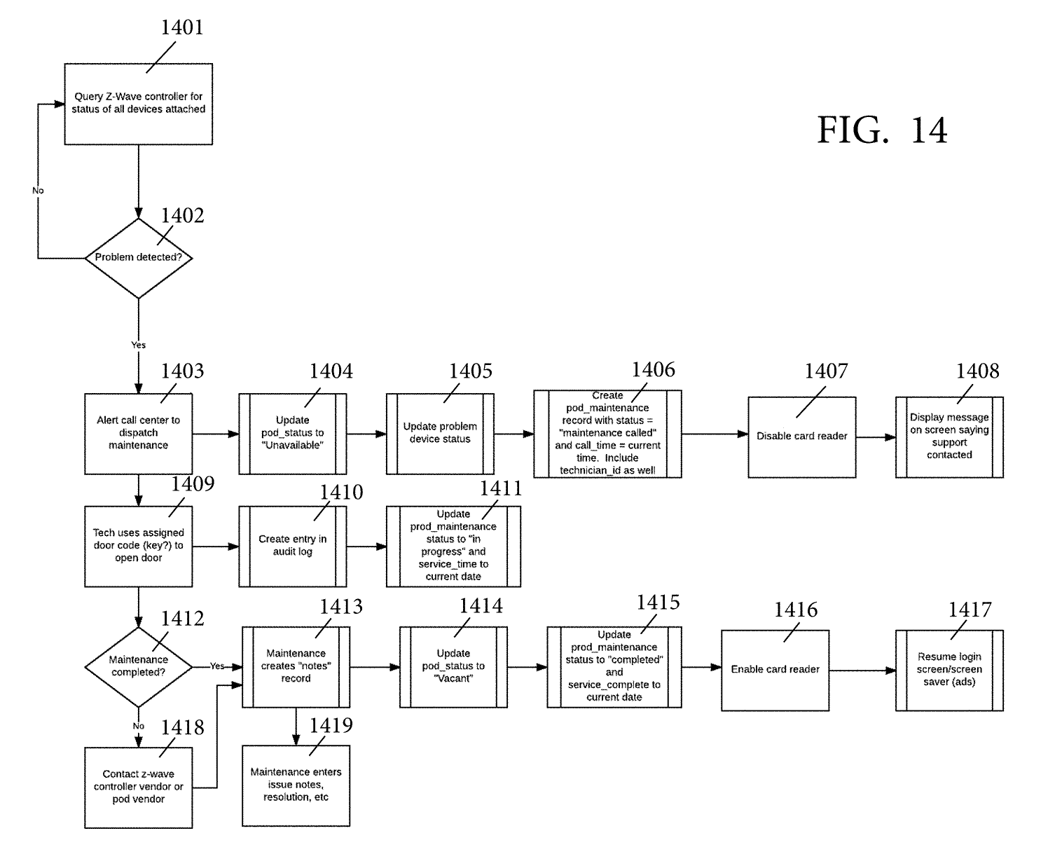

FIG. 14 shows an exemplary process for enclosure maintenance. The system may use a query Z-Wave controller to monitor the status of all devices attached to the enclosure 1401. On an admin screen, a periodic query may foe scheduled. If no device problem is detected after a query, the system will loop back to perform another query after a pre-set interval. If problems are discovered, the system will alert the call center and request dispatch for maintenance 1403. Such alert can be sent using email or text noting device failure. Such failures may include controller malfunction, network failures such as not being able to contact the devices, device or appliance failures such as dead battery or burnt out bulbs, or enclosure power failures. Upon discovery of need for maintenance, the system will update the POD_status description as “Unavailable” 1404. It will create a POD_maintenance Record 1406 and update the problem device status 1405. The POD_maintenance Record may contain data fields such as pm_ID, POD_ID, maintenance_ID, call_time, service_time, service_complete, notes_ID, technician_ID, Status. The Status field is assigned a value of “maintenance called.” The call_time is set to the current time. The system will also disable any card reader or POS device 1407. The outside screen may further display on screen messages indicating that support is getting contacted 1408. When the technician comes on site to perform maintenance, the technician will first use an assigned door code to open the door 1409. Meanwhile, the system will create an Entry_audit record 1410, and make an entry in the audit log. The Entry_audit record may contain data fields such as eaudit_ID, Support_type, Support_ID, and Entry_timestamp. The system will populate the Entry_audit record. The status field of the POD_maintenance Record will be updated to equal “in progress” 1411. The service_time field will be updated to reflect current date 1411. If the technician repairs the problem and complete the maintenance, he may create a Motes Record 1413. The Notes Record may include notes_ID, Notes, and attachment_file_path data fields. This allows the technical to create notes to write down issues, resolutions, etc. 1419. The POD_status description will be updated as “Vacant” 1414. The status field of the POD_maintenance Record will be updated 1414 to equal “completed.” The value for Service_complete will be assigned to the current date. The card reader or POS device will be enabled 1416. The enclosure sill be reset to the login screen or Home Screen 1417. If the technician cannot fix the problem, controller vendor or the manufacturer of the enclosure needs to be contacted 1418.

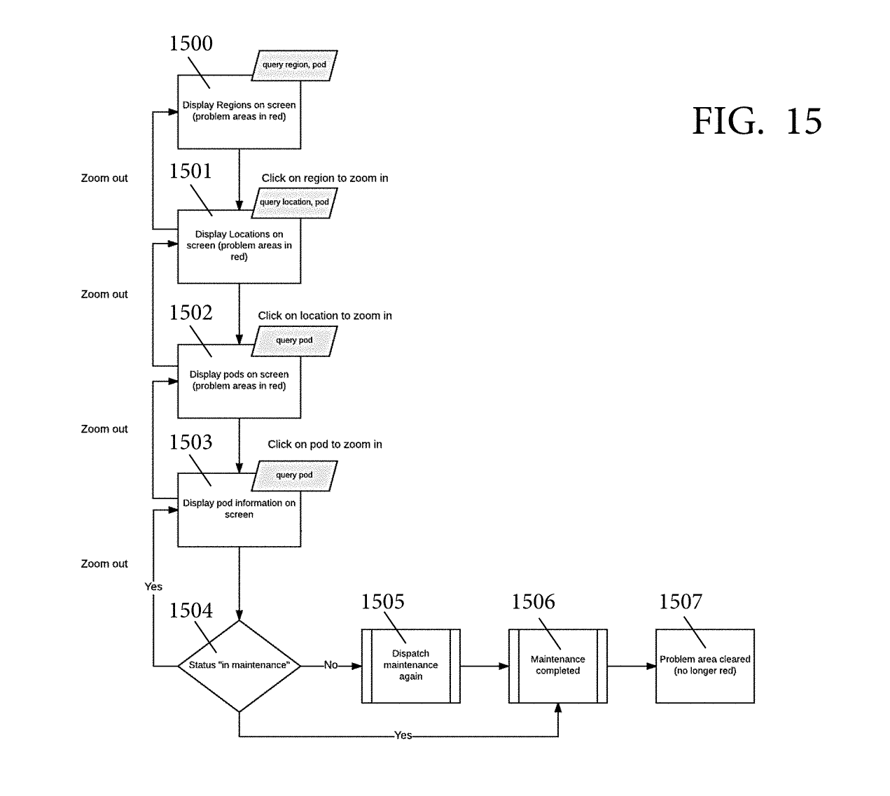

FIG. 15 shows an exemplary process for monitoring all enclosures by a remote call center or management team. A monitor screen can be implemented to display all the enclosures deployed at various regions. If a specific enclosure has device failure, the enclosure will be marked in red, and the region where the enclosure is be shown in red in the monitor screen. An administrator can zoom in to the specific region where the enclosure is located 1500. The administrator can click on the region to further zoom in to the specific location where the enclosure is located 1501. The Administrator can further click on the location to zoom in on the specific enclosure 1502. The Administrator can then click on the enclosure and retrieve information about the Enclosure from the ECS system and display on the monitor screen 1503. The information queried by the system and put on display may include POD_name, POD_status, Power states, Door_status, Lights_status, POD_maintenance Status, etc. If the POD_maintenance Status of the enclosure is “in maintenance” or “in progress” 1504, which means the enclosure is getting repaired or otherwise maintained, the Administrator may choose to zoom out and wait for the completion of the maintenance 1506. If the status of the enclosure is not set as “in maintenance” or “in progress,” then the administrator need to dispatch a maintenance team again 1505. Once the maintenance is completed, the problem area may be cleared, and the red marker be removed 1507.

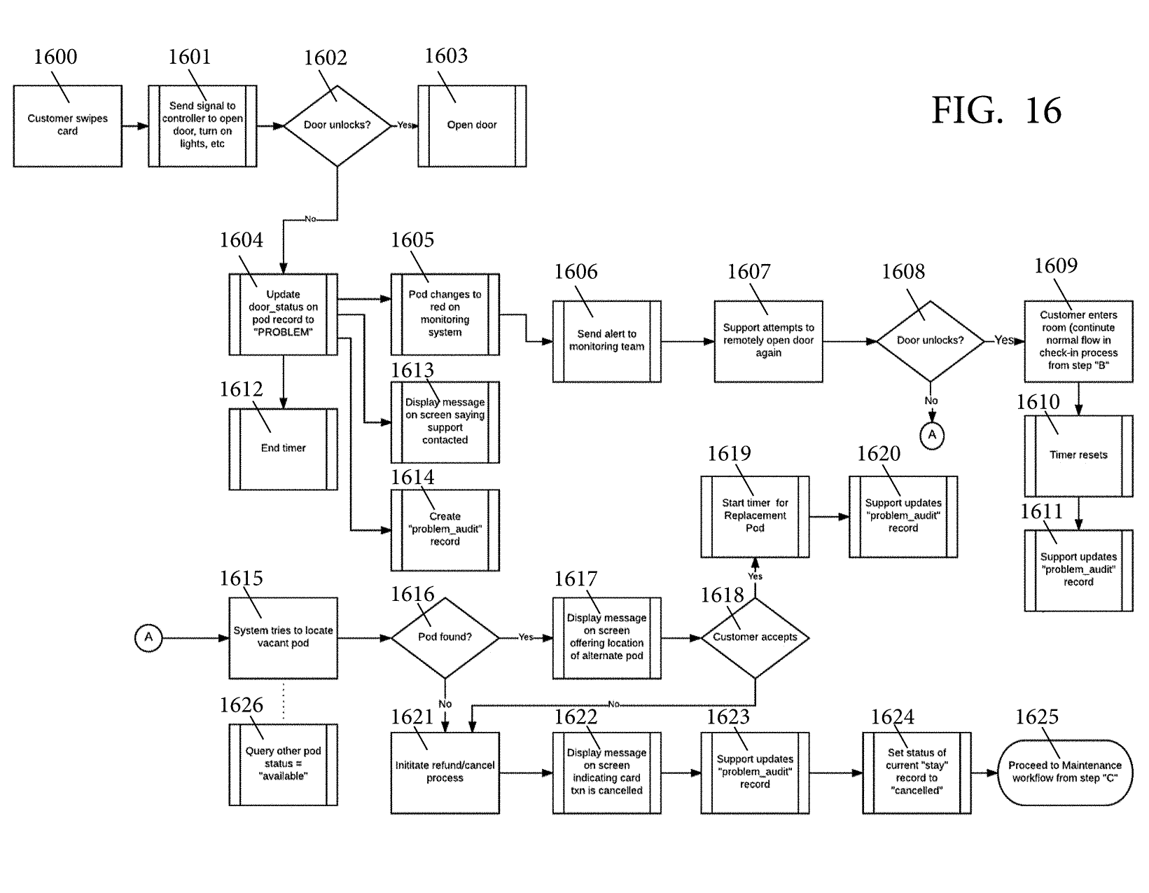

FIGS. 16-19 show how various use scenario will be handled by the present disclosure. FIG. 16 shows a scenario where the door fails to open after a successful Check-in. After the customer swipes his or her credit card 1600 and successfully checks in, a signal is sent to the controller to open the door, turn on the lights, and make other preparations to accommodate the customer 1601. If the door unlocks, the customer will enter the enclosure. If the door fails to unlock, the system will update the door_status on the POD Record to read “Problem” 1604, change the color of the enclosure on the monitor screen to red 1605, and send an alert to the monitoring team 1606. The outside screen of the enclosure displays a message stating that technical support is being contacted 1613. The system will also create a Problem_audit Record 1614. The Record may contain data fields such as Problem_ID, POD_ID, user_D, Issue_ID, problem_datetime, resolution_text, resolution_datetime. The relevant data field of the Record will be updated to reflect

problem issues (e.g., door), as well as the date and time when the problems occurs. Finally, the system will stop the timer when the enclosure is flagged as having problem 1612. when the enclosure is flagged red, the system will also send an alert to the monitoring team 1606. A support team will try to remotely open the door 1607. If the door is successfully unlocked, the customer will enter the enclosure 1609. The normal check-in process as described above in FIG. 8 will resume. The system resets the timer as soon as the customer starts to occupy the enclosure 1610. The Problem_audit Record will be updated accordingly 1611.

If the door cannot be unlocked remotely, the monitoring team will try to locate another vacant enclosure at the same location 1615. If an alternate enclosure is found, the outside screen will display a message and offer the location of the second enclosure to the customer 1617. The customer may choose to accept this alternate arrangement 1618. The customer may then Check-in at the replacement enclosure. Timer for the replacement enclosure will start running 1619. The support team may update the Problem_audit Record 1620. For example, the support team may note in the Resolution_text field that the customer accepted an alternate enclosure, and note in the resolution_datetime field the date and the time the issue is resolved. If a second enclosure is not found at the same location, or the customer declines to accept the alternate offered, then a refund/cancellation process would be initiated 1616. The outside screen will display a message to indicate that the credit card transaction has been cancelled 1622. The support team may also update the Problem_audit Record 1623 by noting how the issue was resolved (through a refund) and the time and date when the issue is resolved. Finally, the system will set the status of the Stay Record to “Cancelled.” The system will proceed to the maintenance process as depicted in FIG. 14.

FIG. 17 shows a scenario where the door is left ajar. If a customer opens the door from inside the enclosure, the system will automatically lock after 5 seconds 1701. If the door is not shut properly, however, the automatic lock may fail. The system uses a smart controller such as Wink to check the status of the door lock in 5 minutes 1702. If the door status reads “locked,” then the system will proceed with normal workflow 1704. If not, then the system will update the POD_status Record by noting the door as having issues 1705. The system may contact the housekeeper and have the housekeeper attempt to close and lock the door at that point 1706.

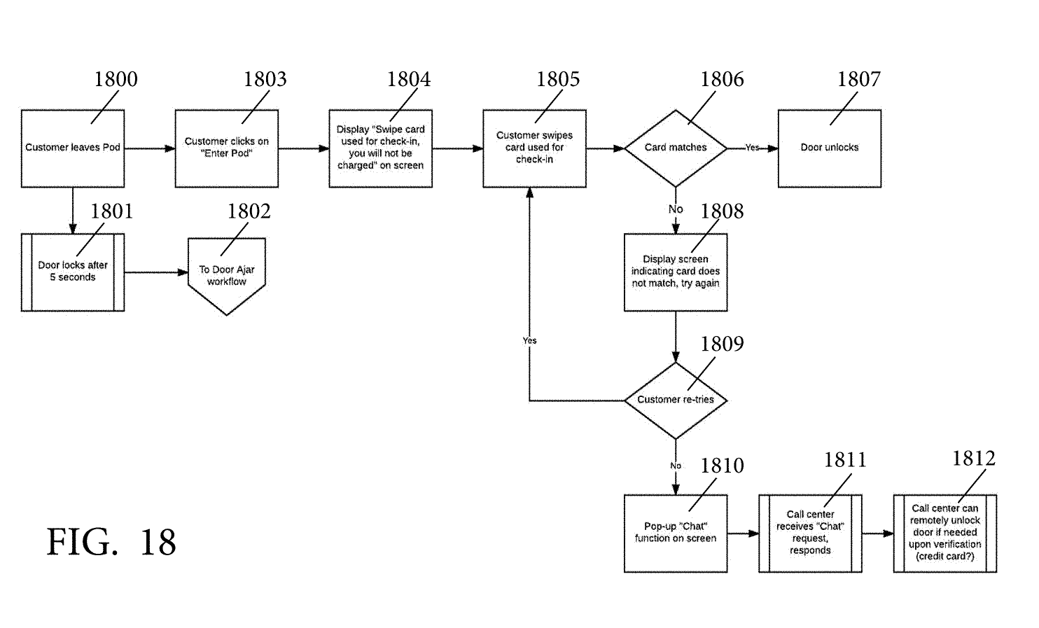

FIG. 18 shows a scenario where a customer leaves the enclosure temporarily such as going to restroom. When the customer leaves the enclosure, the door automatically locks after 5 Seconds 1801. The enclosure will revert to the process for handling door ajar scenario as depicted in FIG. 17. When the customer comes back, he or she needs to go to the outside screen and touch an “Enter Pod” button 1803. The main screen will display a “Swipe card used for check-in, you will not be charged” message 1804. The customer may then swipe the card he or she used for the check-in 1805. If the card matches what is on file, the door unlocks 1807. If the card does not match, then the outside screen will display a message indicating no match and ask the customer to try again 1808. If the customer continues to have problem checking in, the chat window will pop up 1810, allowing the call center to respond to the customer's chat request 1811. The call center may unlock the door upon verification of the identity of the customer 1811.

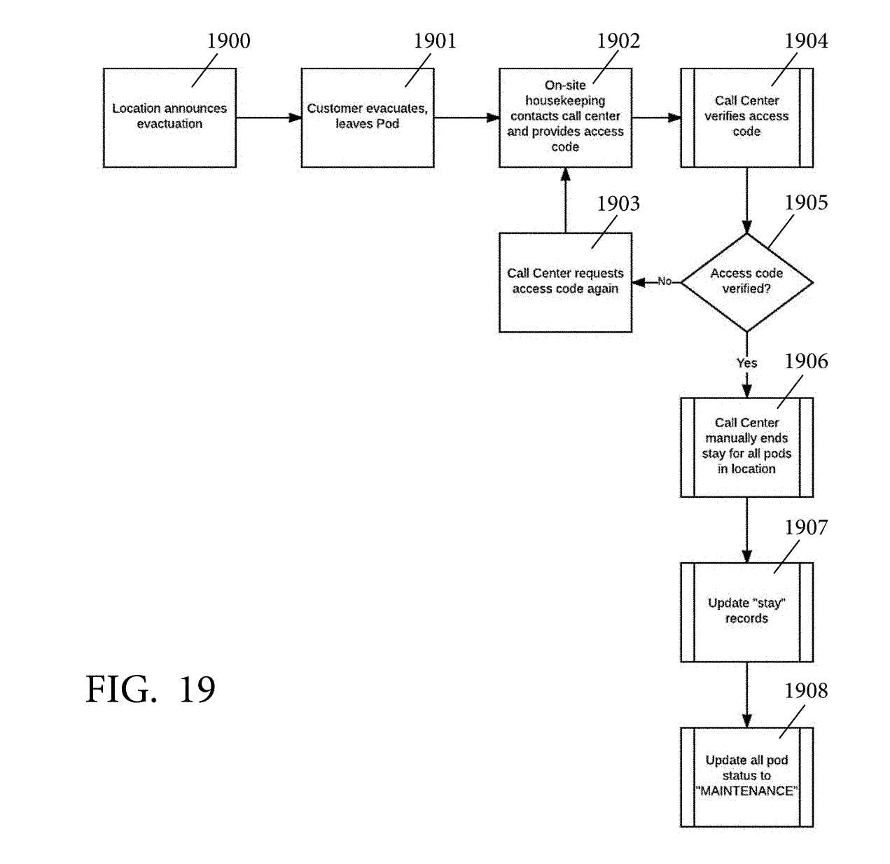

FIG. 19 shows a scenario for emergency evacuation. It starts with a public announcement of evacuation at the location where the enclosure is located. Upon hearing the announcement, a customer will evacuate and leave the enclosure. The on-site housekeeper will also hear the public announcement and contact the call center. The housekeeper will provide an access code to the call center. The call center will verify the access code. If the code cannot be verified, the call center will ask the housekeeper to provide access code again until the code can be verified. Upon verification of the access code, the call center will manually end stay for all the enclosures at the emergency location. The call center will further update the Stay Records for all PODs, and update all POD_status field as “maintenance.”

FIG. 20 shows an exemplary database structure utilized by the ECS and EAS systems. It is an entity relationship diagram depicting the Records generated, maintained, updated, and utilized by the ECS and EAS systems. The diagram further illustrate the relationship between different Records. The diagram also depicts various data fields assigned to each Record. For example, a Stay Record may contain data fields such as stay_ID, POD_ID, location_ID, etc. In a preferred embodiment, Records generated, maintained, updated, and utilized by the ECS and EAS systems will be stored in a cloud server or cloud severs for maximum security.

Having described the disclosure by the description and illustrations above, it should be understood that these are exemplary of the disclosure and are not to be considered as limiting. Accordingly, the disclosure is not to be considered as limited by the foregoing description, but includes any equivalents.

1. A multi-function enclosure providing short term user accommodation comprising:
an enclosure control system responsive to at least a portion of a user's payment source information, comprising:
an entry unit;
a POS interface for verifying the user's payment source information; and
a display unit located outside the enclosure and configured to display the status of the enclosure.

2. The enclosure in claim 1, wherein the enclosure control system is equipped to access data stored in a cloud server or servers.

3. The enclosure in claim 1, wherein the status of the enclosure may be any of the following: vacant, occupied, housekeeping, or maintenance.

4. The enclosure in claim 1, wherein the display unit comprises a touch screen.

5. The enclosure in claim 1, wherein the enclosure control system further comprising a second display unit inside the enclosure and configured to allow the user to order optional services.

6. The enclosure in claim 5, wherein the user may select the optional services from the group comprising of concierge service, media service, and phone service.

7. The enclosure in claim 5, wherein at any time or upon the user's request, the enclosure control system can generate a preliminary bill and display the bill on the display unit.

8. The enclosure in claim 2, wherein the enclosure control system is configured to store notes by service personnel to the cloud server or servers.

9. The enclosure in claim 8, wherein the service personnel is a housekeeper and the data is associated with housekeeping matters about the enclosure.

10. The enclosure in claim 8, wherein the service personnel is a technician and the data is associated with technical matters about the enclosure.

11. The enclosure in claim 1 further comprising seating furniture.

12. The enclosure in claim 1, wherein a user's payment source information comprises of the user's credit card information.

13. The enclosure in claim 12, wherein the portion of a user's credit card information comprises the last four digits of the user's credit card.

14. The enclosure in claim 1, wherein a user may use a pre-registered payment account number as a key for entrance.

15. The enclosure in claim 1, wherein a user may use a pre-registered credit card as a key for entrance.

16. The enclosure in claim 2, wherein the data stored in a cloud server or servers comprises logs of all ingresses and egresses of the enclosure.

17. The enclosure in claim 2, wherein the data stored in a cloud server or servers comprises said portion of the user's payment source information.

18. A method for accessing a multi-function enclosure providing short term accommodation comprising:
pre-registration wherein a user provides contact and a select payment source information;
check-in wherein the user presents a payment method associated with the pre-registered payment source to an automated entry system for automated check-in; and
activation whereby entry to the enclosure and operation of all appliances within the enclosure are activated when the payment source information is verified.

19. The method in claim 18, wherein the select payment source is credit card and the payment method is credit card payment.
